(19) United States
(12) Patent Application Publication
(10) Pub. No.: US 2013/0082678 A1
(43) Pub. Date: Apr. 4, 2013

(54) ELECTRONIC POWER CONDITIONER CIRCUIT

(71) Applicants: Renato Kitchener, West Sussex (GB); Gunther Rogoll, Mannheim (DE)

(72) Inventors: Renato Kitchener, West Sussex (GB); Gunther Rogoll, Mannheim (DE)

(73) Assignee: PEPPERL + FUCHS GMBH, Mannheim (DE)

(21) Appl. No.: 13/696,480

(22) PCT Filed: May 10, 2011
(86) PCT No.: PCT/GB2011/000712

§ 371 Date: Nov. 6, 2012

(30) Foreign Application Priority Data
May 10, 2010 (GB) 1007688.3

(51) Int. Cl. G05F 1/618; G05F 1/46

(52) U.S. Cl. CPC G05F 1/618; G05F 1/46
USPC 323/364

(57) ABSTRACT

An electronic power conditioner circuit for use in an I EC 61 158 Fieldbus network comprising a series element, a capacitor and a resistor formed as a gyrator circuit, and a biasing circuit, in which said biasing circuit supplies a control voltage and/or current to a control terminal of the series element, and in which said biasing circuit is adapted to set said control voltage and/or current such that a voltage drop across the series element is maintained at a pre-determined level.

The present invention relates to a low voltage drop high impedance electronic power conditioner circuit for use particularly in an IEC 61158 Fieldbus circuit.

Fieldbus (or field bus) is the name of a family of industrial computer network protocols used for real-time distributed control, now standardized as IEC 61158. A complex automated industrial system, for example a fuel refinery, usually needs an organized hierarchy of controller systems to function. In this hierarchy there is a Human Machine Interface (HMI) at the top, where an operator can monitor or operate the system. This is typically linked to a middle layer of programmable logic controllers (PLC) via a non time critical communications system (e.g. Ethernet). At the bottom of the control chain is the Fieldbus, which links the PLCs to the components which actually do the work such as sensors, actuators, electric motors, console lights, switches, valves and contactors.

Fieldbus is often used in Intrinsically Safe environments, for example combustible atmospheres, and in particular gas group classification IIC, Hydrogen and Acetylene, and below, for example gas group IIB and IIA, for gas and/or dust. Using the Fieldbus protocol, field instruments and equipment in such an environment are controlled and monitored remotely via an electrical communications circuit often provided in the same electrical circuit as the power to drive the field instruments.

In a typical Fieldbus electrical power and communications circuit there is a power supply, an Intrinsic Safety barrier of some kind, a trunk section leading out into the field, and a number of device couplers with spurs connected thereto, on which the field instruments are mounted. The trunk and the spurs together form a segment. The Intrinsic Safety barrier divides the circuit into an Intrinsically Safe side and a non-Intrinsically Safe side. The power supply, the PLCs and other systems like physical layer diagnostic modules which measure physical layer attributes of the electrical circuit and the network hardware, and in part the physical software or protocol being used, are located in the non-Intrinsically Safe side of the circuit, usually in a control room. The trunk, the device couplers, the spurs and the field instruments are located in the Intrinsically Safe side, out in the field.

Intrinsic Safety can be achieved in a number of known ways, from simply limiting the power so open or short circuits cannot form combustible arcs, to using active monitoring and isolating systems which allow higher power levels and act to isolate the power supply from open or short circuits to prevent combustible arcs.

In IEC 61158 Fieldbus networks a power conditioning component is required to allow for signal modulation by field instruments. This has often simply been a large inductor, but it is also known to use electronic components like gyrators, regulators or active power conditioners. These introduce impedance between two wire digital communications components and the power supply, so communications by means of signal modulation are possible.

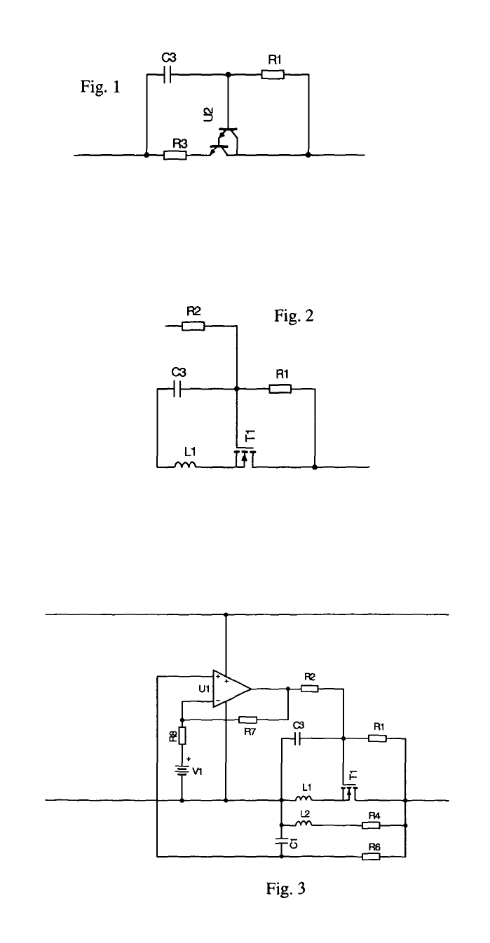

FIG. 1 illustrates such a low-line gyrator/regulator comprising a series element U2, an emitter resistor R3 and a base control/self-bias circuit R1, C3. The series element is shown as a Darlington pair, which is used to enable a low base current and a high impedance. A BJT could be used instead but this would exhibit higher base currents and lower impedance. A MOSFET could also be used, but this would require higher gate voltages, and as a result would create a very high voltage loss.

Although this circuit performs fairly well, it has a few drawbacks. Firstly, the series element U2 loses a voltage in the region of 1.5V or higher under high current, and the emitter resistor R3 used to assist the base modulation loses a voltage in the region of 0.5V at 500 mA and 1 Ohm. This results in a total loss of approximately 2V, which equates to a typical 7 to 10% loss in power supply performance. This is worse in MOSFET designs. In addition, the circuit has poor low frequency performance. With one 100 Ohm terminator removed the onset of distortion is significant. Very little can be done to correct this deficiency without further losses.

The circuit shown in FIG. 1 is prior art, and there are a number of published papers describing variations of the same concept, including: “Foundation Fieldbus Power Supply, A Look At Powering Fieldbus by Analog Services, Inc. (revised Oct. 22, 2000)”, published by Analog Services Inc. based in the USA. This paper is available on the Analog Services website at: www.analogservices.com. In every example given in this paper the series element and the current sense resistor lose a high voltage, and in every case a current sense resistor is used.

The present invention is intended to overcome some of the above problems.

Therefore, according to the present invention an electronic power conditioner circuit for use in an IEC 61158 Fieldbus network comprises a series element, a capacitor and a resistor formed as a gyrator circuit, and a biasing circuit, in which said biasing circuit supplies a control voltage and/or current to a control terminal of the series element, and in which said biasing circuit is adapted to set said control voltage and/or current such that a voltage drop across the series element is maintained at a pre-determined level.

This circuit configuration addresses the series element voltage loss without compromising performance. An increase in the voltage of the control terminal (which would be a base or gate terminal depending on the type of device) as a result of the application of the control voltage and/or current would decrease the equivalent resistance of the series element. As a consequence the power/voltage loss for a given current can be reduced.

The series element can be any element with a power supply terminal, a load terminal and a control terminal, for example a BJT or a Darlington pair of transistors. However, in a preferred construction the series element can be a MOSFET, with the control terminal being the gate terminal thereof.

The use of a MOSFET in the circuit of the invention has distinct advantages. In particular, it has superior impedance performance at a very wide bandwidth. MOSFETS have good low frequency performance, and due to the high gate impedance also allow for a high overall impedance. Further, with a MOSFET the signalling can be symmetrical, and removal of one terminator may not lead to high signal distortion. In addition, the voltage drop can be reduced to 0.5 Volts total in the circuit or even less in some cases.

The biasing circuit can be implemented in any known way using any type of control mechanism, and the logic behind the manner in which it sets the control voltage and/or current can one of several possibilities. In one embodiment the biasing circuit can set the control voltage and/or current at a fixed level. However, this arrangement does suffer from the drawback that the emitted voltage may change, or become to high or low, at differing supply currents.

Therefore, in an alternative embodiment the biasing circuit can vary the control voltage and/or current over time according to a pre-determined rationale. Once again, the technical means by which this can be achieved will be well known to the skilled person. The logic determining the variation in the control voltage and/or current can be set according to the result to be achieved.

For example, in one construction the biasing circuit can further comprise a reference circuit which compares the voltage drop across the series element with a reference voltage. The biasing circuit can vary the control voltage and/or current up or down such that the voltage drop across the series element maintains a pre-determined relationship to the reference voltage. If the reference voltage is, for example, 1.0V, then the control voltage and/or current can be supplied via an impedance (resistor) such that the voltage across the series element is maintained at or around 1V, as opposed to at 4V or 5V, at any current through the series element. Alternatively, the voltage can be maintained at a pre-determined level only when the current through the series element is most influential. For example, a higher or lower voltage drop may not be critical at lower quiescent currents, and therefore control may not be required, but a low voltage drop may be critical at high currents, so control can be applied.

The reference circuit can comprise a low pass filter, to filter out any high frequency component in the measured voltage drop of the series element (contrary to the configurations suggested in the above referred to Analog Services paper). This may be performed at any point in the circuit.

In an alternative to the above, manipulation of the control voltage and/or current can be achieved with a micro controller adapted to vary the control voltage and/or current. This solution allows for further levels of control to be applied. For example, in one embodiment the micro controller can monitor the signal level in the circuit in which the electronic power conditioner circuit is used and vary the control voltage and/or current such that the signal level is maintained at a pre-determined level. In particular, a resistor providing the impedance to the control voltage and/or current can be variable, and it can be adjusted to add in additional impedance to compensate for a missing terminator, thus maintaining the low voltage loss without any signal degradation.

The power conditioner circuit described above has a high impedance over a wide bandwidth. This is a problem at low frequencies, characterised by the rise in the ‘flat tops’ of a trapezoidal wave at −15 kHz to 30 kHz. To compensate for this the electronic power conditioner circuit can further comprise a damping circuit adapted to reduce the impedance of the electronic power conditioner circuit at low frequencies. This leaves the terminators to control the impedance at high frequencies.

The damping circuit can comprise a 5 mH inductor and a 50 Ohm resistor in series. This arrangement exhibits near ideal passive power conditioner performance.

The above described power conditioner circuit addresses the problem of voltage loss over the series element. This still leaves the problem of the voltage loss associated with the emitter resistor in known circuit configurations. To address this issue, and assist in the overall reduction in voltage loss, in any of the embodiments of power conditioner circuits described above the circuit can further comprise an inductor in series with the series element. This inductor can have an inductance less than 5 mH, but preferably the inductance of the inductor can be between 0.05 mH and 0.5 mH.

The purpose of this inductor is to reduce the total voltage loss and to offer a superior high frequency performance, which is lacking in the prior art power conditioner circuits. The use of a MOSFET as the series element provides a superior low frequency performance, so in combination with the inductor, a superior overall circuit design is provided.

The inductor can be used in isolation, or in combination with an emitter resistor. Therefore, in one construction an emitter resistor can also be used.

The invention can be performed in various ways, but two embodiments will now be described by way of example, and with reference to the accompanying drawings, in which:

FIG. 1 is a diagrammatic circuit diagram of a prior art power conditioner circuit;

FIG. 2 is a first embodiment of an electronic power conditioner circuit according to the present invention; and,

FIG. 3 is a second embodiment of an electronic power conditioner circuit according to the present invention.

FIGS. 2 and 3 illustrate the present invention in simple forms for ease of explanation. It will be appreciated that in practice such IEC 61158 Fieldbus power conditioner circuits will be connected to a raw non Intrinsically Safe power supply, and will be fitted into a bus structure including terminators and other components in the known way. Power from the power conditioner circuits will be used on one or more Intrinsically Safe trunks.

Referring to FIG. 2, it shows an electronic power conditioner circuit for use in an IEC 61158 Fieldbus network comprising a series element, MOSFET T1, a capacitor C3 and a resistor R1 formed as a gyrator circuit, and a biasing circuit, visible in FIG. 2 only in the form of the extra input into the gate terminal of the MOSFET T1. As described further below, the biasing circuit supplies a control voltage and/or current to a control terminal of the series element (T1), and is adapted to set said control voltage and/or current such that a voltage drop across the series element (T1) is maintained at a pre-determined level.

As explained above this circuit configuration addresses the series element voltage loss without compromising performance. The increase in the gate voltage of T1 as a result of the application of the control voltage and/or current by the biasing circuit decreases its equivalent resistance. As a consequence the power/voltage loss for any given current is reduced in comparison with prior art examples.

The control voltage and/or current is applied via an impedance, which is generated by resistor R2.

The biasing circuit can be implemented in any known way using any type of control circuitry. As referred to above it can supply a fixed control voltage and/or current, but this has the drawback that the emitted voltage may change, or become to high or low, at differing supply currents. Therefore, the control voltage and/or current can be variable instead, and one way of achieving this is described below in relation to FIG. 3.

In the power conditioner circuit shown in FIG. 2 the emitter resistor R3 of the prior art (shown in FIG. 1) is replaced with a low reactance inductor L1. In this case the inductance of the inductor L1 is between 0.05 mH and 0.5 mH. This inductor L1 reduces the total voltage loss of the power conditioner circuit shown in FIG. 2 in comparison with that shown in FIG. 1, and also offers a superior high frequency performance thereto.

The use of MOSFET T1 provides a superior low frequency performance, so in combination with the inductor L1, a superior overall circuit design is provided. In addition to this, with the MOSFET T1 the signalling can be symmetrical, and removal of one terminator may not lead to high signal distortion.

The combination of the application of the control voltage and/or current to the gate terminal of the MOSFET T1 and the introduction of the inductor L1 reduces the voltage losses of the whole circuit to about 0.5V, which is considerably better than the loss of 2V demonstrated by the circuit shown in FIG. 1.

FIG. 3 shows an enhanced embodiment of the invention with a number of extra features. Where the components are the same as those shown in FIGS. 1 and 2 the same references have been used.

As in the circuit shown in FIG. 2, the circuit shown in FIG. 3 comprises an electronic power conditioner circuit for use in an IEC 61158 Fieldbus network, and includes MOSFET T1, a capacitor C3 and a resistor R1 formed as a gyrator circuit. However, in FIG. 3 a complete automatic biasing circuit is shown. As described below the biasing circuit supplies a control voltage and/or current to the control terminal of the MOSFET T1, and is adapted to set said control voltage and/or current such that a voltage drop across the MOSFET T1 is maintained at a pre-determined level.

The biasing circuit comprises a reference circuit comprising an op amp U1 and reference power supply V1. Resistors R7 and R8 are also included to manage the circuit, although it will be appreciated that these are optional. The reference circuit also comprises a low pass filter circuit comprising resistor R6 and capacitor C1 to filter out any high frequency component of the measurement taken. Further, the reference circuit also comprises a damping circuit comprising 50 Ohm resistor R4 and 5 mH inductor L2 to reduce the impedance at low frequencies.

As is clear from FIG. 3, the reference circuit measures the voltage dropped across the MOSFET T1 and inductor L1, and compares it to the reference voltage V1. The outputted control voltage and/or current from the op amp U1 is then varied such that the voltage across the MOSFET T1 and inductor L1 is maintained at a pre-determined level. If the reference voltage V1 is, for example, 1.0V, then the control voltage and/or current can be supplied via the impedance R2 such that that the voltage across the MOSFET T1 and inductor L1 is maintained at or around 1 V, as opposed to at 4V or 5V, at any current through the series element. Alternatively, the voltage can be maintained at a pre-determined level only when the current through the MOSFET T1 is most influential. For example, a higher or lower voltage drop may not be critical at lower quiescent currents, and therefore control may not be required, but a low voltage drop may be critical at high currents, so control can be applied.

The low pass filter circuit R6 and C1 acts to filter out any high frequency component in the measured voltage drop of the MOSFET T1. The damping circuit R4 and L2 acts to compensate for the power conditioner circuit's high impedance over a wide bandwidth which would be a problem at low frequencies, by bringing the impedance down at such low frequencies. The terminators (not shown) are left to control the impedance at high frequencies. This damping circuit R4 and L2 exhibits near ideal passive power conditioner performance, and also introduces low frequency stability to the power conditioner circuit. The measured voltage drop is then fed to the op amp U1 for the comparison with the reference voltage to be made.

Therefore, if the voltage drop across the MOSFET T1 increases above the reference voltage V1, due to an increase in current flow, the biasing circuit automatically adjusts the MOSFET T1 such that the voltage drop across it is returned to, or maintained at a required voltage. It will be appreciated that this required voltage is determined by the level at which the reference voltage V1 it set.

Therefore, in short the circuit shown in FIG. 3 is a gyrator with enhanced impedance provided by inductor L1, which has means to correct itself using an automatic DC bias control which reduces or stabilises the DC voltage differential across the MOSFET T1 under varying DC current demand, all the while maintaining the required output AC impedance to satisfy the IEC 61158 Fieldbus requirements.

On the whole, the power conditioner circuit is far more stable than those in the prior art, due to the fact that it utilises uses a simple modified gyrator to generate impedance.

The circuits described above can be altered without departing from the scope of claim 1. For example, in one alternative embodiment (not shown), an electronic power conditioner circuit can be provided with a redundant circuit, and a damping circuit comprising R4 and L2 can be placed across the common bus at some point. This can be achieved using a LCR circuit or LC in parallel with the one or more terminators or terminator components.

In another alternative embodiments (not shown) manipulation of the control voltage and/or current is achieved with a micro controller adapted to vary the control voltage and/or current. In one such embodiment the micro controller is further adapted to monitor the signal level in the circuit in which the electronic power conditioner circuit is used, and to vary the control voltage and/or current such that the signal level is maintained at a pre-determined level. In particular, the resistor R2 providing the impedance can be variable, and it can be adjusted to add in additional impedance to compensate for a missing terminator, thus maintaining the low voltage loss without any signal degradation.

Therefore, the present invention provides an electronic power conditioner solution which significantly reduces the voltage losses associated with known electronic solutions.

1. An electronic power conditioner circuit for use in an IEC 61158 Fieldbus network comprising a series element, a capacitor and a resistor formed as a gyrator circuit, and a biasing circuit, in which said biasing circuit supplies a control voltage and/or current to a control terminal of the series element, and in which said biasing circuit is adapted to set said control voltage and/or current such that a voltage drop across the series element is maintained at a pre-determined level.

2. An electronic power conditioner circuit as claimed in claim 1 in which the series element is a MOSFET.

3. An electronic power conditioner circuit claimed in claim 2 in which the biasing circuit sets the control voltage and/or current at a fixed level.

4. An electronic power conditioner circuit as claimed in claim 2 in which the biasing circuit varies the control voltage and/or current over time according to a pre-determined rationale .

5. An electronic power conditioner circuit as claimed in claim 4 in which the biasing circuit comprises a reference circuit which compares the voltage drop across the series element with a reference voltage, and in which the biasing circuit varies the control voltage and/or current up or down such that the voltage drop across the series element maintains a pre-determined relationship to the reference voltage.

6. An electronic power conditioner circuit as claimed in claim 5 in which the reference circuit comprises a low pass filter.

7. An electronic power conditioner circuit as claimed in claim 4 in which the biasing circuit comprises a micro controller adapted to vary the control voltage and/or current.

8. An electronic power conditioner circuit as claimed in claim 7 in which the micro controller monitors a signal level in the circuit in which the electronic power conditioner circuit is used, and varies the control voltage and/or current such that the signal level is maintained at a pre-determined level.

9. An electronic power conditioner circuit as claimed in claim 4 in which the electronic power conditioner circuit further comprises a damping circuit adapted to reduce the impedance of the electronic power conditioner circuit at low frequencies.

10. An electronic power conditioner circuit as claimed in claim 9 in which the damping circuit comprises a 5 mH inductor and a 50 Ohm resistor in series.

11. An electronic power conditioner circuit as claimed in claim 1 in which the electronic power conditioner circuit further comprises an inductor in series with the series element.

12. An electronic power conditioner circuit as claimed in claim 11 in which said inductor has an inductance less than 5 mH.

13. An electronic power conditioner circuit as claimed in claim 12 in which the inductance of the inductor is between 0.05 mH and 0.5 mH.
